(19) United States
(12) Patent Application Publication
(10) Pub. No.: US 2013/0078458 A1
(43) Pub. Date: Mar. 28, 2013

(54) METHOD FOR THE LOW-TEMPERATURE PREPARATION OF ELECTRICALLY CONDUCTIVE MESOSTRUCTURED COATINGS

(71) Applicants: Claudine Biver, Charenton Le Pont (FR); Sandrine Duluard, Charenton Le Pont (FR); Joëlle Corde, Palaiseau (FR); Jean-Pierre Boilot, Palaiseau (FR); Thierry Gacoin, Palaiseau (FR); Sandrine Perruchas, Palaiseau Cedex (FR)

(72) Inventors: Claudine Biver, Charenton Le Pont (FR); Sandrine Duluard, Charenton Le Pont (FR); Joëlle Corde, Palaiseau (FR); Jean-Pierre Boilot, Palaiseau (FR); Thierry Gacoin, Palaiseau (FR); Sandrine Perruchas, Palaiseau Cedex (FR)

(73) Assignees: Centre National de la Recherche Scientifique -CNRS-, Paris (FR); Essilor International (Compagnie Generale D'Optique), Charenton Le Pont (FR)

(21) Appl. No.: 13/702,043

(22) PCT Filed: May 26, 2011
(86) PCT No.: PCT/FR2011/051205

§ 371 Date: Dec. 4, 2012

(30) Foreign Application Priority Data
Jun. 9, 2010 (FR) 1054532

(51) Int. Cl. B05D 3/06

(52) U.S. Cl. CPC B05D 3/065
USPC 428/336; 428/450; 427/558

(57) ABSTRACT

The present invention relates to a method for manufacturing mesostructural coatings comprising electrically conductive structures formed of metal nanoparticles. Said method includes the steps that involve: a) depositing on a substrate, a first layer consisting of a silica material, mesostructured by a structuring agent, and a photocatalytic material: b) depositing on the first layer, a second layer of a mesostructural silica material, said second layer being free of photocatalytic material: c) consolidating the first and second layers at at temperature between 50° C. and 250° C.; and d) placing the consolidating coating in contact with a solution that contains and irradiatting coating with a radiation that enables the photocatalytic material to be activated. Said method is characterized in that it includes no heat treatment at a temperature greater than 250° C.

The present invention relates to the manufacture of a coating comprising one or more electrically conducting structures consisting of metallic nanoparticles. The metallic nanoparticles are created by photoreduction catalyzed by a photocatalytic material, preferably titanium dioxide. Said manufacture does not comprise any step of heating at a temperature above about 250° C., which means that this coating can be produced on plastic substrates.

The photoreduction of metal ions on the surface of a photocatalytic material is a technique that is known from the prior art. It is based on the following principle: A photocatalytic material is a semiconductor. When it is exposed to luminous radiation whose wavelength corresponds at least to the energy that separates its valence band from its conduction band, it absorbs this energy and an electron-hole pair is created. The photoelectron is then available for reducing a chemical species present on the surface of the catalyst. The photocatalysts are generally metal oxides or sulfides with wide forbidden bands. Activation of the catalyst is generally performed with radiation whose wavelength corresponds to the ultraviolet.

The formation of extremely fine conductive structures consisting of metallic nanoparticles can thus be performed in situ by photoreduction of metal ions in the context of photolithographic techniques. Such structures are of very considerable interest in areas that require very precise spatial localization, such as microfluidics, electronic nanocircuits, optical distribution frames, DNA chips and laboratories on chips, chemical and biological sensors, etc.

The preparation of coatings comprising metallic nanoparticles obtained by photocatalysis has already been described in the literature, in particular in the work by Eduardo D. Martinez, Martin G. Bellino and Galo J. A. A. Soller-Illia, titled “Patterned Production of Silver-Mesoporous Titania Nanocomposite Thin Films Using Lithography-Assisted Metal Reduction” (ACS Appl. Mater. Interfaces, 2009, 1 (4) , pp 746-749, published on the Internet Mar. 13, 2009).

This work describes in particular the manufacture of mesoporous SiO₂/TiO₂ bilayer coatings, which are impregnated with silver nitrate, and then irradiated with UV through a lithographic mask.

Production of this mesoporous coating necessarily includes a step of calcination of the deposited layers at 350° C. for 2 hours. This calcination is carried out in particular for the following reasons:
Firstly it allows calcination of the structure-forming agent (surfactant used for forming the mesopores) as well as of other residual organic species optionally present, used in the sol-gel deposition process.
It makes it possible to obtain a mesoporous layer of titanium oxide that is mainly amorphous but has a minor fraction of Ti^{IV} sites having an environment of the anatase type, which have been shown to be indispensable for the photocatalytic properties of TiO₂ (see for example patent application WO 03/087002).

The main drawback of this method, proposed by Martinez et al., is that because of this step of high-temperature calcination, it can only be used on substrates that are resistant to such temperatures. In particular, it is impossible to carry out such a process on an organic polymer substrate.

The present invention is based on the rather surprising discovery that the step of calcination of the deposits, employed by Martinez et al., seems to be superfluous and that a similar method lacking any step of thermal treatment at high temperature gives results for the conductivity of the structures created that are equivalent to or even higher than those obtained with a method envisaging calcination of the organic components.

The applicant discovered in particular that it is sufficient to submit the mesostructured coatings, after sol-gel deposition thereof, to a simple step of maturation at moderately high temperature (less than or equal to 250° C.), for the purpose of consolidation of said coatings.

Owing to the omission of the calcination step, it thus becomes possible to create, on the surface of polymer substrates, in particular transparent and/or flexible polymer substrates, conductive structures of very small size that can be used for example as structured electrodes.

The present invention relates to a method for the manufacture of a mesostructured coating comprising electrically conducting structures formed from metallic nanoparticles consisting of a metal selected from the group consisting of Ag, Au, Pd and Pt, preferably Ag, comprising the steps consisting of:

a) sol-gel deposition, on a substrate, of a first layer of a material, mesostructured by a structure-forming agent, based on silica and a photocatalytic material;

b) sol-gel deposition on the first layer, deposited during step a), of a second layer of a material, mesostructured by a structure-forming agent, based on silica, said second layer being free from photocatalytic material;

c) consolidating the first and second layers, by submitting them together to a treatment of maturation at a temperature between 50° C. and 250° C., for a time between 10 minutes and 200 hours;

d) contacting the consolidated coating obtained in step c) with a solution containing metal ions selected from the group consisting of ions of silver, gold, palladium and platinum, preferably silver, and irradiating it with radiation permitting activation of the photocatalytic material, for a sufficient time to reach the percolation threshold, beyond which metallic nanoparticles obtained by photocatalyzed reduction of metal ions together form an electrically conducting structure,

said method being characterized in that it does not include any thermal treatment at a temperature above 250° C.

The present invention also relates to a mesostructured coating comprising electrically conducting structures formed from metallic nanoparticles, obtainable by said method.

Finally, the present invention also relates to the use of this mesostructured coating as an electrode, as an antistatic coating or, on account of its reflective properties, as a heat-insulating coating.

The present invention therefore relates to a method for the manufacture of a mesostructured coating comprising electrically conducting structures formed from metallic nanoparticles. The metal is selected from the group consisting of Ag, Au, Pd and Pt. Preferably, said metallic nanoparticles are silver nanoparticles.

The method according to the invention comprises a step a) consisting of forming by the sol-gel route, on a substrate, a first layer of a mesostructured material by a structure-forming agent. This material is based on silica and a photocatalytic material, in other words the silica and the photocatalytic material represent, together, at least 30 wt %, preferably at least 50 wt % of said material, the remainder being formed by the structure-forming agent and any impurities introduced by the sol-gel process.

The sol-gel processes are processes that are well known by a person skilled in the art, for forming a solid, amorphous three-dimensional network by hydrolysis and condensation of precursors in solution.

The first layer of mesostructured material, formed in step a) of the method, contains silica, a photocatalytic material and an organic structure-forming agent.

Preferably, silica represents between 5 and 45 wt % of the mesostructured material.

The structure-forming agent preferably represents between 5 and 60 wt % of the mesostructured material. The use of these structure-forming agents for forming mesostructured or mesoporous materials is known. This structure-forming agent has the role of forming mesopores in this material. The term “mesopores” denotes pores with a diameter between 2 and 50 nm (nanometers). Mesoporous materials are obtained by removing the structure-forming agent, for example by calcination. Until the structure-forming agent has been removed, it occupies the mesopores, and the material is called “mesostructured”, i.e. it has mesopores filled with structure-forming agent. The structure-forming agent can be a polymer or a surfactant.

Preferably, the structure-forming agent is selected from the nonionic surfactants.

Advantageously, block copolymers are used, preferably block copolymers based on ethylene oxide and propylene oxide.

Examples of nonionic structure-forming agents that are preferred in the present invention are poloxamers, marketed under the name Pluronic®.

It is also possible to use cationic surfactants, for example surfactants with a quaternary ammonium group.

The photocatalytic material is preferably a metal oxide. It is preferably selected from the group consisting of titanium dioxide, zinc oxide, bismuth oxide and vanadium oxide, or a mixture thereof. Especially preferably, the photocatalytic material is titanium dioxide TiO₂.

Preferably, the weight ratio of photocatalytic material to silica in the first layer is between 0.05 and 2.7.

When the photocatalytic material is titanium dioxide, the atomic ratio Ti/Si is preferably between 0.05 and 2, in particular between 0.5 and 1.5, and more preferably between 0.8 and 1.2.

The photocatalytic material according to the invention is in the physical form that it requires so that it effectively has photocatalytic properties. For example, TiO₂ must be at least partially crystalline, preferably in the anatase form.

According to one embodiment of the present invention, the photocatalytic material is present in the first layer in the form of particles in a silica matrix, for example nanoparticles with a diameter between 0.5 and 300 nm, notably between 1 and 80 nm. These nanoparticles can themselves consist of smaller grains or elementary crystallites. These particles can also be agglomerated or aggregated with one another.

Step a) of the method according to the invention can comprise the following substeps:

i) preparing a sol containing at least one silica precursor, preferably a tetraalkoxysilane, such as tetraethoxysilane, dissolved in an aqueous-organic solvent containing a catalyst of acid or basic hydrolysis as well as the structure-forming agent;

ii) adding photocatalytic material, preferably in the form of nanoparticles, to this sol;

iii) applying the suspension obtained on a substrate.

Typically, the aqueous-organic solvent is an alcohol/water mixture, the alcohol typically being methanol or ethanol.

The sol can be applied on the substrate by techniques that are known by a person skilled in the art, for example by spin coating, by dip coating or by roll coating.

According to the present invention, the substrate can consist of any suitable solid material. If the electrically conducting structures formed are intended to be used as electrodes, the substrate is preferably a nonconducting substrate. It can for example comprise traditional substrates of glass, Pyrex®, silica etc. Preferably, however, the substrate is an organic polymer. As examples of suitable organic polymers, we may mention poly(ethylene terephthalate), polycarbonate, polyamides, polyimides, polysulfones, poly(methyl methacrylate), copolymers of ethylene terephthalate and carbonate, polyolefins, notably polynorbornenes, homopolymers and copolymers of diethyleneglycol bis(allylcarbonate), (meth)acrylic homopolymers and copolymers, notably the (meth)acrylic homopolymers and copolymers derived from bisphenol A, thio(meth)acrylic homopolymers and copolymers, homopolymers and copolymers of urethane and thiourethane, epoxide homopolymers and copolymers and episulfide homopolymers and copolymers, cotton in the form of bulk material, film or thread.

In fact, the method according to the invention has the advantage that it does not include any thermal treatment at a temperature above 250° C. Thus, this method is particularly recommended for use on a polymer substrate that cannot withstand prolonged exposure to temperatures above 250° C. If the intended application is in the area of optics or for windows, in particular a transparent polymer substrate will be used.

Step b) of the method according to the invention consists of sol-gel deposition, on the first layer deposited during step a), of a second layer of a mesostructured material by a structure-forming agent, based on silica, said second layer being free from photocatalytic material. Advantageously, the first coating is not submitted to any intermediate heating between step a) and step b). In fact, as will be demonstrated below using a comparative example, the applicant found that the conductivity of the metallic structures formed was significantly poorer when the first layer was submitted to a thermal treatment before depositing the second layer. However, the first coating can advantageously be submitted to a treatment of maturation before depositing the second layer, said treatment of maturation consisting of keeping the first layer under a humid atmosphere, at room temperature, for a time between 15 minutes and 2 hours. The relative humidity (RH) of said atmosphere is preferably between 60 and 80%.

According to one embodiment, this second layer is deposited in the same way as the first layer, the only difference being absence of the photocatalytic material. In particular, the silica precursor (tetraalkoxysilane), the catalyst, the solvent and the structure-forming agent can be the same as those used for the first layer. The sol-gel process can also be used in the same way. However, this is not indispensable.

Step b) of the method according to the invention can comprise the substeps consisting of:

i) preparing a sol containing at least one silica precursor, preferably a tetraalkoxysilane, such as tetraethoxysilane, dissolved in an aqueous-organic solvent containing a catalyst of acid or basic hydrolysis as well as the structure-forming agent;

ii) applying this sol on the first layer, formed during step a).

Step c) of the method according to the invention consists of consolidating the first and second layers by submitting them together to a treatment of maturation. This treatment of maturation consists of exposing the substrate and the two layers to a temperature between 50° C. and 250° C., for a time between 10 minutes and 200 hours.

Preferably, the treatment is carried out at a temperature between 70° C. and 140° C., more preferably between 80° C. and 125° C., and even more preferably between 100° C. and 120° C. The duration of this treatment is between 10 minutes and 200 hours, preferably between 2 and 36 hours, more preferably between 8 and 24 hours, and even more preferably between 10 and 16 hours. The duration of this maturation step advantageously becomes shorter as the temperature of the thermal treatment is increased. Especially preferably, the following conditions can be applied: a time between 11 and 13 hours at a temperature between 100° C. and 120° C.

The consolidation treatment in step c) can be carried out by suitable techniques, known by a person skilled in the art, for example in a furnace, in the open air, etc.

As the temperature of this treatment carried out during said step c) is less than or equal to 250° C., the mesostructure-forming agent present in the pores of the deposited materials is not removed.

Finally, step d) of the method according to the invention consists of contacting the consolidated coating, obtained in step c), with a solution containing metal ions, the metal being selected from the group consisting of Ag, Au, Pd and Pt, preferably Ag, and irradiating it with radiation capable of activating the photocatalytic material, for a sufficient time to reach the percolation threshold, beyond which metallic nanoparticles, obtained by photocatalyzed reduction of the metal ions, together form an electrically conducting structure.

The solution containing metal ions can be selected from a salt solution, for example based on nitrate, chloride, acetate, or tetrafluoroborate.

Preferably, it is:
a solution of silver nitrate (for Ag), or
a solution of gold chloride (HAuCl₄) (for Au), or
a solution of palladium chloride (PdCl₂) (for Pd), or
a solution of platinum chloride (H₂PtCl₆) (for Pt).

The solvent can be a water/isopropanol mixture.

According to a preferred embodiment of the present invention, the coating obtained in step c) is immersed in the solution containing metal ions. However, contacting of the solution with the coating can also be performed by spraying, spin coating, with a jet of material, of the ink jet type, or by coating.

The radiation for activating the photocatalytic material is preferably UV radiation, preferably near-UV radiation. “UV radiation” generally means radiation whose wavelength is between 10 and 400 nm, and “near-UV radiation” means radiation whose wavelength is between 200 and 400 nm. In particular, when the photocatalytic material is TiO₂, irradiation can typically be carried out with a commercially available UV lamp.

According to a first embodiment of the method of the present invention, the coating formed by superposition of the first and second layers, consolidated together, is brought in contact with the solution of metal ions, in particular by immersion, while the irradiation is carried out. This ensures a constant supply of metal ions.

According to a second embodiment of the present invention, the coating is first impregnated with the solution of metal ions, then it is rinsed and/or dried, and then irradiated, in other words the coating is not in contact with the solution of metal ions during irradiation. This embodiment offers the advantage of being easier to carry out, as irradiation can take place separately in time and in space from the contacting with the coating. However, it is necessary for sufficient metal ions to be introduced into the coating, prior to the irradiation step, so that the percolation threshold can be reached.

Preferably, the irradiation carried out in step d) takes place by means of a radiation source emitting in the wavelength region in question, in particular in the UV. It can for example be a mercury vapor lamp, a laser or a diode. The irradiation can be performed through a mask, preferably a photolithography mask, so as to inscribe a conductive pattern on the substrate.

As explained in the introduction, the method according to the present invention is characterized in that it does not include any thermal treatment at a temperature above 250° C., preferably above 200° C., even more preferably above 140° C.

The methods described in the prior art necessarily include a step in which the coating undergoes a thermal treatment at high temperature, i.e. above 250° C., said thermal treatment being denoted for example by the terms “annealing”, “calcination”, or “heat treatment”.

The applicant found, quite surprisingly, that this step of treatment at more than 250° C. was not necessary for fabricating mesostructured coatings having electrically conducting structures formed from metal particles.

As will be demonstrated below in comparative examples, omission of the steps of annealing or calcination at high temperature even leads to a significant and quite unexpected improvement in the conductivity of the electrically conducting structures formed.

Thus, the method according to the invention makes it possible to manufacture mesostructured coatings with electrically conducting structures having a conductivity above 20 S/cm. These “elevated” conductivities had already been obtained by Martinez et al. on mesoporous materials, i.e. materials whose structure-forming agent had been removed by calcination, but never on mesostructured materials still containing the organic structure-forming agent.

The method according to the present invention makes it possible to produce coatings comprising electrically conducting structures formed from metallic nanoparticles selected from ions of Ag, Au, Pd and Pt, preferably Ag.

“Electrically conducting” means a material capable of conducting electric current, in contrast to a semiconductor or an insulator. The electrically conducting structures that are contained in the coating according to the invention have a conductivity above 20 S/cm, preferably above 70 S/cm, and even more preferably above 90 S/cm, the conductivity being measured by the van der Pauw method.

The conductivity can in fact be measured by two different methods:

The first method allows rapid measurement and therefore monitoring of the conductivity as a function of the irradiation time and therefore of the quantity of metallic nanoparticles, notably of silver, formed on one and the same film. This measurement is carried out using an instrument for measuring surface resistivity made by Microworld, according to the four-point method (or van der Pauw method). The surface of the coating is brought in contact manually with a “4-point head”. The 4 points are each one millimeter apart. The value given is the mean value of 10 measurements made at 10 different places on the coating. This measurement is performed through the first layer, which is insulating, (http://www.microworldgroup.com/products/productInfo_fr .aspx?=produit=329).

The second method consists of positioning two studs of silver lacquer on the coating, one centimeter apart, and measuring the resistivity of the coating with an ohmmeter between these 2 points. The value given is obtained from a single measurement. The silver lacquer penetrates into the porous coating and comes in contact with the conductive layer. This measurement can only be performed after the end of irradiation and consequently does not permit monitoring in real time.

The thickness of the various layers constituting the coating according to the present invention depends on the parameters of deposition of these layers during step a) and step b) of the method according to the present invention, as well as on the consolidation treatment in step c) of the method according to the present invention.

Preferably, the first layer of mesostructured material of the coating according to the invention has a thickness, after consolidation, between 200 and 2000 nm, more preferably between 400 and 800 nm.

Preferably, the second layer of mesostructured material of the coating according to the present invention has a thickness, after consolidation, between 50 and 1000 nm, more preferably between 100 and 300 nm.

Consequently, the total thickness of the mesostructured coating, after consolidation, according to the present invention is preferably between 250 and 3000 nm, more preferably between 500 and 1100 nm.

This coating meets a real need. In fact, by using photolithography masks, the electrically conducting structures that they contain are extremely fine and can be positioned with very great precision.

In fact, the method according to the invention has the advantage that it does not include any thermal treatment at a temperature above 250° C. Thus, this method is particularly recommended for use on a polymer substrate that has various properties, in particular on a transparent and/or flexible polymer substrate.

That is why the coating according to the present invention is particularly suitable for use as an electrode.

### EXAMPLES

1. Preparation of a coating according to the invention (coating A):
Preparation of a solution 1, heated under reflux for 1 hour at 60° C., and consisting of:
   11 mL of TEOS (tetraethoxysilane)
   11 mL of ethanol
   4.5 mL of HCl at pH−1.25
Dissolve 1.47 g of Pluronic® PE6800 (structure-forming agent) in 20 mL of ethanol (with stirring under hot water), then add 10 mL of solution 1. Filter this solution 2 with a NYLON filter 450 nm.
Take 4 mL of solution 2, to which 0.857 mL of TiO₂ Millennium S5-300A (Cₘ=231 g/L) is added. After stirring, deposit the whole by spin-coating on a glass substrate (2000 rev/min for one minute). The first layer is thus deposited.
Keep the film under humid atmosphere (RH=65% imposed with a saturated solution of magnesium acetate) for 30 minutes.
Deposit solution 2 again alone on the first layer by spin-coating in the same conditions as above and again keep the film under humid atmosphere (RH=65%) for 30 minutes.
The film then undergoes a thermal treatment of 12 hours at 110° C.

2 . Comparative Examples:

Three comparative coatings B, C and D were prepared according to the protocol described for coating A, except that:
Coating B was submitted to two annealing steps at 110° C: Once the first layer is deposited, it is first treated thermally at 110° C. for 12 hours before receiving the second layer, and then the two layers together are submitted to annealing for 12 hours at 110° C. In this case the two layers are mesostructured, i.e. they still contain the structure-forming agent.
Coating C was submitted to one annealing at 450° C.: The two layers were deposited successively and were calcined together at 450° C. In this case, these two layers are mesoporous, i.e. the pores of the structure are empty, the structure-forming agent having been removed by calcination.
Coating D was submitted to two annealing steps at 450° C.: Once the first layer is deposited, it is first calcined at 450° C. before receiving the second layer, and then the two layers together are submitted to calcination at 450° C. In this case, as the calcination results in decomposition of the structure-forming agent, the two layers are mesoporous, as in coating C.

3. Results:

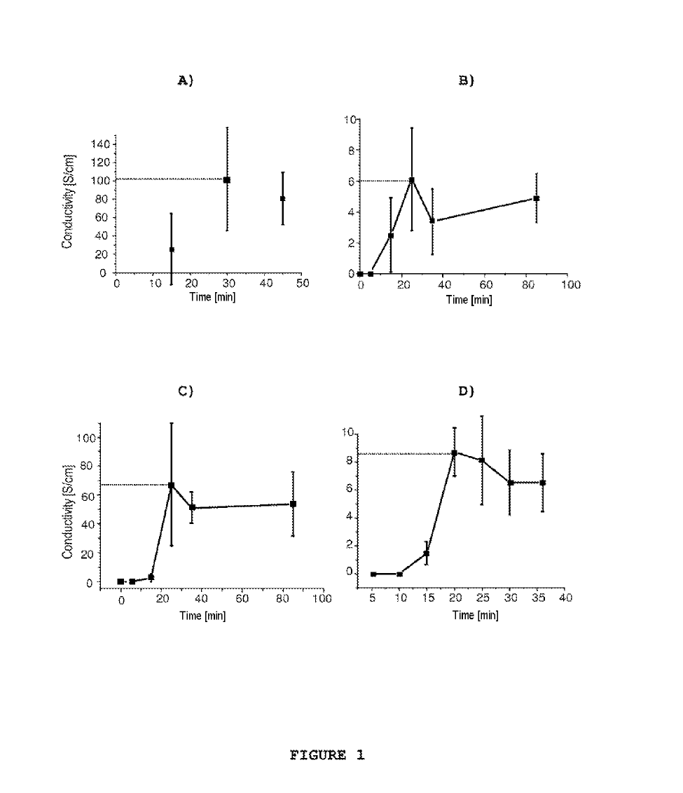

The results are shown in FIG. 1. Graphs A, B, C and D represent the respective variation of the conductivity of coatings A, B, C and D (measured by the four-point method), as a function of the irradiation time (UV lamp at 312 nm) in the presence of a solution of AgNO₃ at 0.05 M in a 50:50 mixture of water and isopropanol.

It can be seen that maximum conductivity is obtained for an irradiation time of about 20 to 30 minutes. This is the time taken to reach the percolation threshold.

The following table presents the maximum values of conductivity obtained for each coating:

| | A | | B | | C | | D | |
|---|---|---|---|---|---|---|---|---|
| | (inven- | | (compar- | | (compar- | | (compar- | |
| | tion) 1 | | ative) 2 | | ative) 1 | | ative) 2 | |
| | annealing | | annealings | | annealing | | annealings | |
| | at 110° C. | | at 110° C. | | at 450° C. | | at 450° C. | |
| Maximum | 100 | S/cm | 6 | S/cm | 67 | S/cm | 8.7 | S/cm |
| conductivity | | | | | | | | |
| measured | | | | | | | | |
| by method | | | | | | | | |
| No. 1 | | | | | | | | |
| (at four | | | | | | | | |
| points) | | | | | | | | |
| Maximum | 264 | S/cm | 32 | S/cm | 119 | S/cm | 67 | S/cm |
| conductivity | | | | | | | | |
| measured | | | | | | | | |
| by method | | | | | | | | |
| No. 2 | | | | | | | | |
| (studs of | | | | | | | | |
| silver | | | | | | | | |
| lacquer) | | | | | | | | |

On comparing coatings A and B, it can be seen that by not carrying out annealing between deposition of the first and second layer, a coating can be obtained with a far higher conductivity.

Moreover, when coatings A and C are compared, it can also be seen, quite surprisingly, that when annealing is carried out at only 110° C., it is possible to obtain a mesostructured coating having a conductivity that is equivalent, or even greater than that of a mesoporous coating obtained after annealing at 450° C.

1. A method for manufacturing mesostructured coatings having electrically conducting structures formed from metallic nanoparticles of a metal selected from the group consisting of Ag, Au, Pd and Pt, comprising:
a) sol-gel depositing, on a substrate, of a first layer of a material, mesostructured by a structure-forming agent, based on silica and a photocatalytic material;
b) sol-gel depositing on the first layer deposited during step a), of a second layer of a material, mesostructured by a structure-forming agent, based on silica, said second layer being free from photocatalytic material;
c) consolidating the first and second layers, by submitting them together to a treatment of maturation at a temperature between 50° C. and 250° C., for a time between 10 minutes and 200 hours;
d) contacting the consolidated coating obtained in step c) with a solution containing metal ions selected from the group consisting of ions of silver, gold, palladium and platinum, and irradiating with radiation permitting activation of the photocatalytic material, for a sufficient time to reach a percolation threshold, beyond which metallic nanoparticles obtained by photocatalyzed reduction of the metal ions together form an electrically conducting structure,
wherein said method does not include any thermal treatment at a temperature above 250° C.

2. The method as claimed in claim 1, wherein the photocatalytic material is a metal oxide.

3. The method as claimed in claim 1, wherein the structure-forming agent is selected from nonionic surfactants.

4. The method as claimed in claim 1, wherein the photocatalytic material is titanium dioxide and that the atomic ratio Ti/Si, in the mesostructured material of the first layer, is between 0.05 and 2.

5. The method as claimed in claim 1, wherein the substrate is an organic polymer, in the form of bulk material, film or thread.

6. The method as claimed in claim 1, wherein the irradiation carried out in step d) takes place through a mask.

7. A mesostructured coating comprising electrically conducting structures formed from metallic nanoparticles, obtainable by the method as claimed in claim 1.

8. The mesostructured coating as claimed in claim 7, wherein the electrically conducting structures have a conductivity above 20 S/cm, measured by the van der Pauw method.

9. The mesostructured coating as claimed in claim 7, wherein the first layer of mesostructured material has a thickness between 200 and 2000 nm.

10. The mesostructured coating as claimed in claim 7, wherein the second layer of mesostructured material has a thickness between 50 and 1000 nm.

11.-13. (canceled)

14. The method as claimed in claim 2, wherein the photocatalytic material is selected from the group consisting of titanium dioxide, zinc oxide, bismuth oxide and vanadium oxide, or a mixture thereof.

15. The method as claimed in claim 3, wherein the structure-forming agent is selected from block copolymers based on ethylene oxide and propylene oxide.

16. The method as claimed in claim 4, wherein the atomic ratio Ti/Si, in the mesostructured material of the first layer, is between 0.5 and 1.5.

17. The method as claimed in claim 5, wherein the substrate is an organic polymer selected from the group consisting of poly(ethylene terephthalate), polycarbonate, polyamides, polyimides, polysulfones, poly(methyl methacrylate), copolymers of ethylene terephthalate and carbonate, polyolefins, notably polynorbornenes, homopolymers and copolymers of diethyleneglycol bis(allylcarbonate), (meth)acrylic homopolymers and copolymers, thio(meth)acrylic homopolymers and copolymers, homopolymers and copolymers of urethane and thiourethane, epoxide homopolymers and copolymers and episulfide homopolymers and copolymers, cotton.

18. The method as claimed in claim 6, wherein the irradiation carried out in step d) takes place through a photolithography mask.
